(19) United States
(12) Patent Application Publication
(10) Pub. No.: US 2014/0237272 A1
(43) Pub. Date: Aug. 21, 2014

(54) POWER CONTROL FOR DATA PROCESSOR

(71) Applicant: ADVANCED MICRO DEVICES, INC., Sunnyvale, CA (US)

(72) Inventor: Greg Sadowski, Cambridge, MA (US)

(73) Assignee: ADVANCED MICRO DEVICES, INC., Sunnyvale, CA (US)

(21) Appl. No.: 13/770,311

(22) Filed: Feb. 19, 2013

(51) Int. Cl. G06F 1/32

(52) U.S. Cl. CPC G06F 1/3275
USPC 713/320; 713/300

(57) ABSTRACT

A data processor includes a data processor core, and a power controller. The data processor core is adapted to control an external memory system and to perform a task by accessing the external memory system, where the task has an associated computation rate, and the data processor is adapted to control the external memory system by powering up the external memory system when needed. The power controller is coupled to the data processor core for controlling a power consumption of the data processor core and the external memory system by issuing control signals to change an activation time and an activation frequency of the data processor core and the memory system.

### FIELD

This disclosure relates generally to data processing systems, and more specifically to data processors with power control.

### BACKGROUND

In complementary metal oxide semiconductor (CMOS) integrated circuits, in order to reduce power consumption, modern microprocessors have adopted dynamic power management using “P-states”. A P-state is a voltage and frequency combination. An operating system (OS) determines the frequency to complete the current tasks and causes an on-chip power state controller to set the clock frequency accordingly. For example, if on average the microprocessor is heavily utilized, then the OS determines that the frequency should be increased. On the other hand if on average the microprocessor is lightly utilized, then the OS determines that the frequency should be decreased. The available frequencies and corresponding voltages for proper operation at those frequencies are stored in a P-state table. As the operating frequency increases, the corresponding power supply voltage also increases, but it is important to keep the voltage low while still ensuring proper operation.

Computer systems perform real-time execution of an application program. For correct execution of these programs, the computer system is expected to meet strict timing deadlines and to complete execution of a certain tasks within constrained periods. The constrained period is typically from a certain time “t₀” when the computer system launches an event to a certain time “t₁” when the computer system receives a response. However choosing a P-state from among a limited number of P-states may not be adequate to reduce power as much as possible.

### BRIEF DESCRIPTION OF THE DRAWINGS

FIG. 1 illustrates in block diagram form a data processing system according to some embodiments.

FIG. 2 illustrates in block diagram form a power controller that may be used to implement the power controller of FIG. 1 according to some embodiments.

FIG. 3 illustrates a graph helpful in understanding power consumption versus operating voltage of the data processing system of FIG. 1 according to some embodiments.

FIG. 4 illustrates a graph helpful in understanding operating clock frequency versus operating voltage of the data processing system of FIG. 1 according to some embodiments.

FIG. 5 illustrates a flow diagram of a method for controlling power for the data processing system of FIG. 1 according to some embodiments.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

A data processor generally can include multiple central processing unit (CPU) cores, at least one graphics processing unit (GPU) core, a system controller known as a “Northbridge” (NB), a DRAM memory controller, and a physical-layer controller adapted to control an external memory system. A data processor as disclosed below includes a data processor core such as a CPU core or a GPU core and a power controller. The data processor core is adapted to control an external memory system and to perform a task by accessing the external memory system, where the task has an associated computation rate, and the data processor is adapted to control the external memory system by powering up the external memory system when needed. The power controller is connected to the data processor core for controlling a power consumption of the data processor core and the external memory system by issuing control signals to change an activation time and an activation frequency of the data processor core and the memory system.

In some embodiments, a power controller for a data processor includes a leakage calculator, a power calculator and controller circuit, and a control signal generator. The leakage calculator receives a temperature signal, an operating frequency value, an operating voltage value, and provides a leakage power signal. The power calculator and controller circuit receives the operating frequency value, and the operating voltage value. The control signal generator has an input connected to an output of the power calculator and controller circuit, and provides the operating frequency value, the operating voltage value, a clock signal at a frequency corresponding to the operating frequency value, and a voltage corresponding to the operating voltage value.

Thus, a power controller as described herein can dynamically control the power consumption of the data processing system, where the power consumption includes at least dynamic power, leakage power, and power of the memory system, based on operating voltage and frequency during both active periods and idle periods. The power controller can dynamically adjust frequency and voltage operating points of the data processing system and can adjust to changing operating conditions, for example, silicon characteristics, operating temperature, an amount of work to be performed over a time period, a type of work to be performed, and characteristics of the data processor core performing the calculations. In particular, while the data processing system is active, the power controller works with the operating system to change the processing duration and the power state to lower power while the data processor cores complete each task to achieve an associated computation rate.

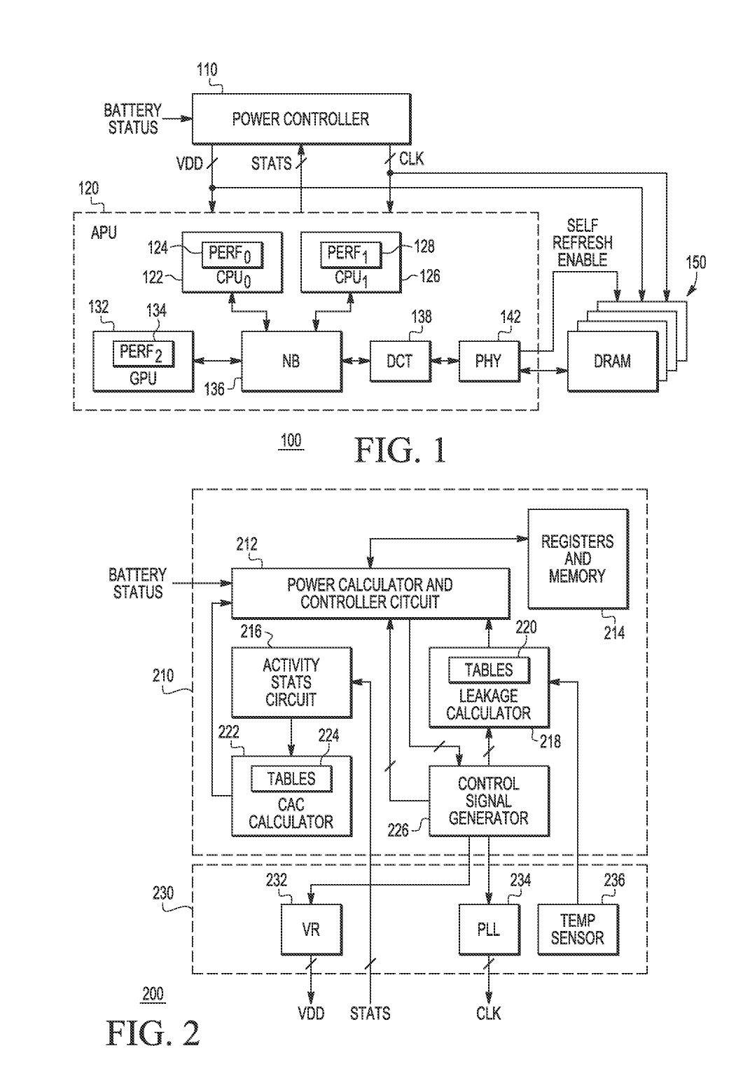

FIG. 1 illustrates in block diagram form a data processing system 100 according to some embodiments. For the example shown in FIG. 1, data processing system 100 generally includes a power controller 110, an accelerated processing unit (“APU”) 120, and a dynamic random access memory (DRAM) memory system 150.

Power controller 110 has a first input to receive a signal labeled “BATTERY STATUS”, a second input to receive a set of activity signals labeled “STATS”, a first output to provide a set of operating voltage signals labeled “VDD”, and a second output to provide a set of clock signals labeled “CLK”.

APU 120 has a first input connected to the first output of power controller 110 to receive at least one of the VDD operating voltage signals, a second input connected to the second output of power controller 110 to receive at least one of the CLK signals, and an output connected to the second input of power controller 110 to provide the STATS activity signals. APU 120 includes data processor cores in the form of a CPU core 122 labeled “CPU₀”, a CPU core 126 labeled “CPU₁”, a GPU core 132, a NB 136, a DRAM memory controller 138 labeled “DCT”, and a physical-layer controller 142 labeled “PHY”. CPU core 122, CPU core 126, and GPU core 132 respectively include performance counters 124 labeled “PERF₀”, performance counters 128 labeled “PERF₁”, and performance counters 134 labeled “PERF₂”.

NB 136 has four bidirectional ports including a first bidirectional port connected to CPU core 122, a second bidirectional port connected to CPU core 126, a third bidirectional port connected to GPU 132, and a fourth bidirectional port. DCT 138 has a first bidirectional port connected to the fourth bidirectional port of NB 138, and a second bidirectional port. PHY 142 has a first bidirectional port connected to the second bidirectional port of NB 138, a second bidirectional port, and an output for providing a signal labeled “SELF REFRESH ENABLE”.

Memory system 150 has a bidirectional port connected to the second bidirectional port of PHY 142, a first input to receive the SELF REFRESH ENABLE signal, a second input connected to the first output of power controller 110 to receive at least one of the VDD operating voltage signals, and a third input connected to the second output of power controller 110 to receive at least one of the CLK signals.

In operation, the data processor cores perform a set of tasks during active periods and at least a portion of their internal circuits remain idle between the active periods. For example, GPU core 132 performs periodic video processing computations during active periods and remains idle between the active periods. During idle periods of data processing system 100, power controller 110 controls power consumption by lowering the operating frequency of the corresponding CLK signal and lowering the corresponding VDD according to the settings in the P-state table, and ultimately gating off a power supply voltage or a clock signal to selected portions of data processing system 100. In some embodiments, power controller 110 controls the power consumption of both at least one of the data processor cores and memory system 150 by issuing control signals to change their activation time and activation frequency. Thus power controller 110 achieves further power reduction by considering more factors than just the operation of a single core in isolation.

In some embodiments, to further reduce power consumption, APU 120 asserts the SELF REFRESH ENABLE signal to memory system 150. After APU 120 asserts the SELF REFRESH ENABLE signal, power controller 110 can disable the clock signal to memory system 150. In self refresh mode, memory system 150 is able to retain its contents even in the absence of an external clock signal.

During active periods of data processing system 100, one or more active data processor cores execute instructions. Data processing system 100 powers up memory system 150 when needed to execute instructions and to access data associated with the instructions and, in embodiments which implement it, deactivates the SELF REFRESH ENABLE signal. The processor cores each provide memory access requests to NB 136. NB 136 stores accesses for dispatch to DCT 138. DCT 138 schedules memory requests from NB 136 to memory system 150. DCT 138 also manages the efficient operation of memory system 150, for example, scheduling refresh cycles at appropriate times, reordering burst accesses to minimize conflicts among memory banks, prioritizing read and write accesses, and combining accesses on the same memory page to facilitate parallelism of accesses. PHY 142 provides an interface between NB 136 and DRAM memory system 150. To access data, PHY 142 provides standard CONTROL signals, base address signals, and ADDRESS signals to memory system 150. Since APU 120 performs tasks that have an associated computation rate, APU 120 completes tasks in a certain amount of time based on at least the CLK signal operating frequency and the corresponding VDD operating voltage provided by power controller 110.

During the active periods, power controller 110 controls the power consumption of data processing system 100 by issuing control signals that change, for example, the activation frequency and the activation time of both a data processor core and memory system 150. Here, activation time indicates how long data processing system 100 operates in the active mode before transitioning to the idle mode. Programs with real-time processing requirements have an overall instruction processing rate, but data processing system 100 can operate each data processor core and memory system 150 with an activation time and activation frequency that achieves this overall processing rate while reducing overall system power consumption. APU 120 also provides the STATS activity signals to power controller 110, and power controller 110 measures dynamic power consumption based on the activity signals.

In some embodiments, when a battery supplies the operating voltage, data processing system 100 also provides the BATTERY STATUS signal to power controller 110 to indicate the status of the battery. Power controller 110 further controls the power consumption of data processing system 100 taking into account battery parameters, for example, the discharge status, the temperature, the discharge current, and the operating voltage.

In some embodiments, CPU cores 122 and 126 and GPU core 132 use performance counters 124, 128, and 134, respectively, to make frequency and processing duration measurements of specific events related to the latency or throughput of instruction execution and data movement through APU 120. Performance counters 124, 128, and 134 each measure specific events over corresponding time periods, for example, how busy the floating point unit is, the number of pipeline restarts, and how many memory accesses data processing system 100 makes for particular tasks. APU 120 provides at least some of the STATS activity signals to power controller 110, based on the measurements. In some embodiments, power controller 110 also estimates power consumption of external memory system 150 based on operating frequency and corresponding operating voltage of data processing system 100. In some embodiments, NB 136 also includes performance counters (not shown) to measure, for example, data movement through data processing system 100.

By taking into account both the power consumption of the data processor cores and the memory system, data processing system 100 is better able to reduce power consumption compared to known data processing systems. In some embodiments, power controller 110 further controls power consumption of data processing system 100 by taking into account all components of power consumption, including not only dynamic power consumption but also leakage power and the estimated power consumption of memory system 150. In some embodiments, power controller 110 also takes into account the power consumption of voltage regulators 232, since voltage regulator efficiency varies with the level of current.

In some embodiments, unlike known systems that set “worst case” conditions in a P-state table, where the P-state table has limited voltage and frequency combinations, power controller 200 dynamically calculates multiple voltage and frequency combinations based on, for example, a set of power models. Power controller 100 further interpolates more voltage and frequency combinations when the operating environment of data processing system 100 supports a finer tuned power state to achieve yet lower power operation.

FIG. 2 illustrates in block diagram form a power controller 200 that may be used to implement a portion of power controller 110 of FIG. 1 according to some embodiments. For the example shown in FIG. 2, power controller 200 generally includes a power control processor 210 and a set of circuits 230.

Power control processor 210 includes a power calculator and controller circuit 212, a registers and memory block 214, an activity stats circuit 216, a dynamic capacitance (“CAC”) calculator 222, a leakage calculator 218 that includes a set of leakage tables 220, and a control signal generator 226. Together activity stats circuit 216 and CAC calculator 222 form a capacitance calculator.

Power calculator and controller circuit 212 has a first input to receive the BATTERY STATUS signal, a second input to receive a dynamic capacitance value, a third input to receive a first set of signals including an operating frequency value and an operating voltage value, a fourth input to receive a leakage power signal, an output to provide a third set of signals, and is connected to the set of registers and memory 214. Activity stats circuit 216 has an input to receive the STATS signals, and an output. CAC calculator 222 has an input connected to the output of activity stats circuit 216, an output connected to the second input of power calculator and controller circuit 212 to provide the dynamic capacitance value, and includes a set of power tables 224. Leakage calculator 218 has a first input to receive a second set of signals including an operating frequency value and an operating voltage value, a second input to receive a temperature signal, an output connected to the fourth input of power calculator and controller circuit 212 to provide the leakage power signal, and includes a set of leakage tables 220. Control signal generator 226 has an input connected to the output of power calculator and controller circuit 212 to receive the third set of signals, a first output connected to the first input of leakage calculator 218 to provide the second set of signals including the operating frequency value and the operating voltage value, a second output connected to the third input of power calculator and controller circuit 212 to provide the first set of signals including the operating frequency value and the operating voltage value, a third output, and a fourth output.

The set of circuits 230 includes a set of voltage regulators 232 labeled “VR”, a set of phase-locked loops 234 labeled “PLL”, and a temperature sensor 236. Voltage regulators 232 have an input connected to the third output of control signal generator 226, and an output to provide the set of VDD operating voltage signals. PLL 234 has an input connected to the fourth output of control signal generator 226, and an output to provide the set of CLK signals. Temperature sensor 236 has an output connected to the second input of leakage calculator 218 to provide the temperature signal.

In some embodiments, the voltage regulators and the PLLs are variously distributed among the blocks of data processing system 100. For example, voltage regulators 232 may be off-chip from APU 120, while PLLs 234 are on-chip. However power controller 200 determines the operating voltage of each one of the voltage regulators and the operating frequency of each one of the PLLs by providing the set of VDD operating voltage signals and the set of CLK signals, respectively, to the appropriate physical locations of these circuits.

In operation, data processing system 100 consumes power based not only on the amount of time the data processor cores are active, but also based on the amount of time memory system 150 is active and the amount of power consumption due to leakage power during the inactive times. To achieve a certain processing rate, a data processor core can run faster for a shorter period of time, or slower for a longer period of time. Power control processor 210 takes into account all of these source of power consumption to allow for a better tradeoff between active and idle times and thus to reduce power consumption over known systems.

Power controller 200 controls the power consumption of data processing system 100, during both the active periods and the idle periods. During the active periods, power controller 200 dynamically adjusts frequency and voltage combinations based on changing operating conditions. In particular, while data processing system 100 is active, power controller 200 works with the operating system to change the processing duration and the power state, to lower power while the data processor cores complete each task to achieve a computation rate.

In some embodiments, power calculator and controller circuit 212 controls power consumption of data processing system 100 using software power models and additional power model information stored in the set of registers and memory 214. The power models represent dynamic power consumption, leakage power, and estimated power consumption of memory system 150, based on operating voltage.

Leakage calculator 218 estimates leakage power based on the temperature signal, the operating frequency, and the operating voltage. In some embodiments leakage calculator 218 further provides the leakage power signal based on a set of leakage tables 220 that store multiple values representing a weighted average of both active and idle leakage power, based on silicon characteristics, temperature, and voltage. Automatic test equipment measurements of APU 120 determine at least some of the values stored in the set of leakage tables 220. Power calculator and controller circuit 212 has the capability to interpolate an even larger set of leakage power values based on current values stored in the set of leakage tables 220.

In some embodiments, dynamic capacitance calculator 222 includes a set of power tables 224 to store power models of various activities of data processing system 100. During active time periods, power controller 200 stores power models based on dynamic capacitance values. Power calculator and controller circuit 212 calculates dynamic power consumption of each processor core, which is equal to the capacitance of the integrated circuit times the frequency of operation times the square of the voltage, or

P=CV²f [1]

Power controller 200 changes an activation time and an activation frequency of at least portions of data processing system 100, including memory system 150, based on the power models.

Control signal generator 226 receives the power control commands from power calculator and controller circuit 212 and properly sequences the power supply voltage and operating frequency to ensure proper operation. For example to increase the clock frequency, control signal generator 226 first increases the power supply voltage. Only after the voltage has stabilized at its higher level can it increase the operating frequency. Control signal generator provides signals indicating the current voltage and frequency to power calculator and controller circuit 212 and leakage calculator 218 so they can perform their respective computations.

By taking into account more contributors to system power consumption, power controller 200 sets the operating point to better reduce power consumption. In some embodiments, power controller 200 controls the power consumption of both a data processor cores and the memory system to change their activation time and activation frequency. In some embodiments, power controller 200 considers dynamic power consumption, leakage power, and power of the memory system. Power controller 200 can calculate these contributors to total power based on operating voltage and frequency during both active periods and idle periods.

Moreover, the power controller dynamically adjusts frequency and voltage operating points of the data processing system and can further adjust to changing operating conditions, for example, silicon characteristics, operating temperature, an amount of work to be performed over a time period, a type of work to be performed, and characteristics of the data processor core performing the calculations. In some embodiments, while the data processing system is active, the power controller works with the operating system to change the processing duration and the power state, to lower power while the data processor cores complete each task to achieve an associated computation rate.

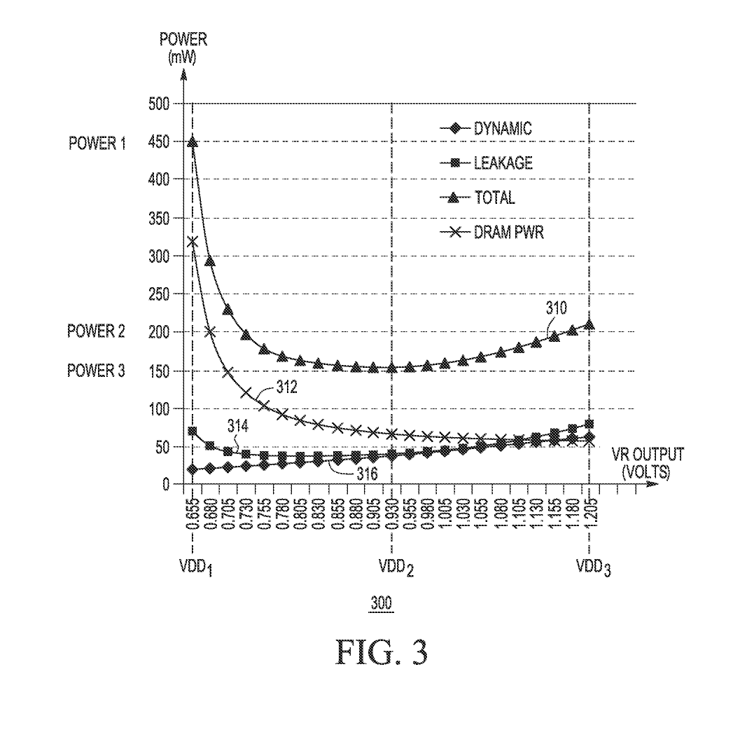

FIG. 3 illustrates a graph 300 helpful in understanding power consumption versus operating voltage of data processing system 100 of FIG. 1 according to some embodiments. The example shown in FIG. 3 represents the playback of a video clip requiring 2.8 million instruction cycles over a period of 33 milliseconds, in which APU 120 manufactured in 28 nanometer CMOS technology and is operating at a temperature of 75 degrees centigrade.

In FIG. 3, the horizontal axis represents operating voltage of data processing system 100 in volts (VOLTS) from about 0.655 volts to about 1.205 volts, and the vertical axis represents power consumption of data processing system 100 in milliwatts (mW) from 0 mW to about 500 mW. Three points of interest on the horizontal axis are at about 0.655 volts labeled “VDD₁”, at about 0.930 volts labeled “VDD₂”, and at about 1.205 volts labeled “VDD₃”. Three points of interest on the vertical axis are at about 450 mW labeled “POWER₁”, at about 200 mW labeled “POWER₂”, and at about 150 mW labeled “POWER₃”.

In FIG. 3, waveform 310 represents the total power consumption versus operating voltage of data processing system 100, waveform 312 represents power consumption versus operating voltage of memory system 150, waveform 314 represents leakage power consumption versus operating voltage of data processing system 100, and waveform 316 represents dynamic power consumption versus operating voltage of data processing system 100.

Voltage VDD₁ represents the voltage corresponding to the lowest frequency that will meet the real-time processing requirements of the video playback program. This operating point represents relatively slow processing of instructions at a reduced voltage. At this operating point, the data processor core is active for a longer period of time but at a lower voltage. If power controller 110 operates the data processor core at voltage VDD₁, it causes a relatively high total power consumption of about 450 mW (POWER₁). At VDD₁, a significant percentage of the total power consumption is based on the power consumed by memory system 150, while dynamic power consumption of the data processor core is low.

Voltage VDD₃ represents the voltage needed for the highest supported frequency. This operating point represents relatively fast processing of instructions at a higher voltage. If power controller 110 operates the data processor core at voltage of VDD₃, it reduces the total power consumption to about 200 mW. At VDD₃, dynamic power consumption and leakage of the data processor core is higher than at VDD₁, but memory system 150 is active for a shorter amount of time, and it lowers the total power consumption.

Voltage VDD₂ is the voltage needed for an intermediate frequency. This operating point represents intermediate speed processing of instructions at its corresponding voltage. By operating the data processor core at VDD₂, power controller 110 can reduce the total power consumption further to about 150 mW (POWER₂), which is lower than at VDD₃.

By taking into account not only dynamic power consumption of the data processor core but other sources of power consumption such as leakage power and memory system power, data processing system is able to lower total power consumption.

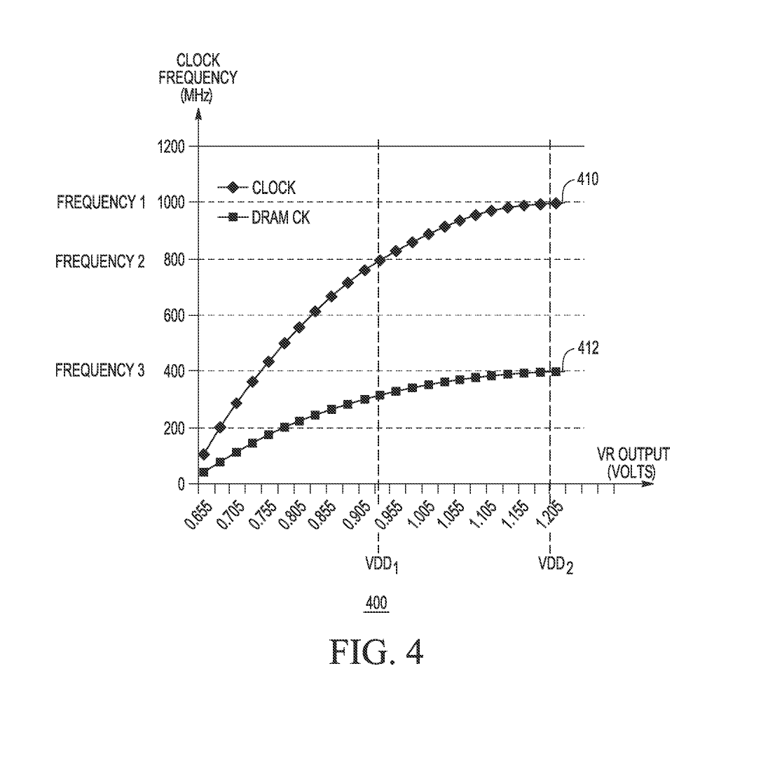

FIG. 4 illustrates a graph 400 helpful in understanding operating clock frequency versus operating voltage of data processing system 100 of FIG. 1 according to some embodiments. The horizontal axis represents operating voltage of data processing system 100 in volts from about 0.655 volts to about 1.205 volts, and the vertical axis represents frequency operating points of data processing system 100 in megahertz (MHz) from 0 MHz to about 1200 MHz. Two points of interest on the horizontal axis are at about 0.955 volts labeled “VDD₁” and at about 1.205 volts labeled “VDD₂”. Three points of interest on the vertical axis are at about 1000 MHz labeled “FREQUENCY₁”, at about 800 MHz labeled “FREQUENCY₂”, and at about 400 MHz labeled “FREQUENCY₃”.

Waveform 410 represents operating voltage versus clock frequency of data processing system 100, and waveform 412 represents operating voltage versus clock frequency of memory system 150. At point VDD₁, power controller 200 provides around an 800 MHz clock to data processing system 100, and around a 350 MHz clock to memory system 150. At point VDD₂, power controller 200 provides around a 1000 MHz (1.0 gigahertz) clock to data processing system 100, and around a 400 MHz clock to memory system 150. Note that at higher operating voltages, power controller 200 provides hi_{g}her corresponding clock frequeₙcies to data processing system 100.

Based on automatic test equipment measurements, power calculator and controller circuit 212 uses the multiple voltage and clock frequency combinations to construct the power models and leakage tables of data processing system 100. As explained above, power calculator and controller circuit 212 further interpolates between the multiple voltage and clock frequency combinations to determine additional low power operating points for finer tuning of the low power operation of data processing system 100.

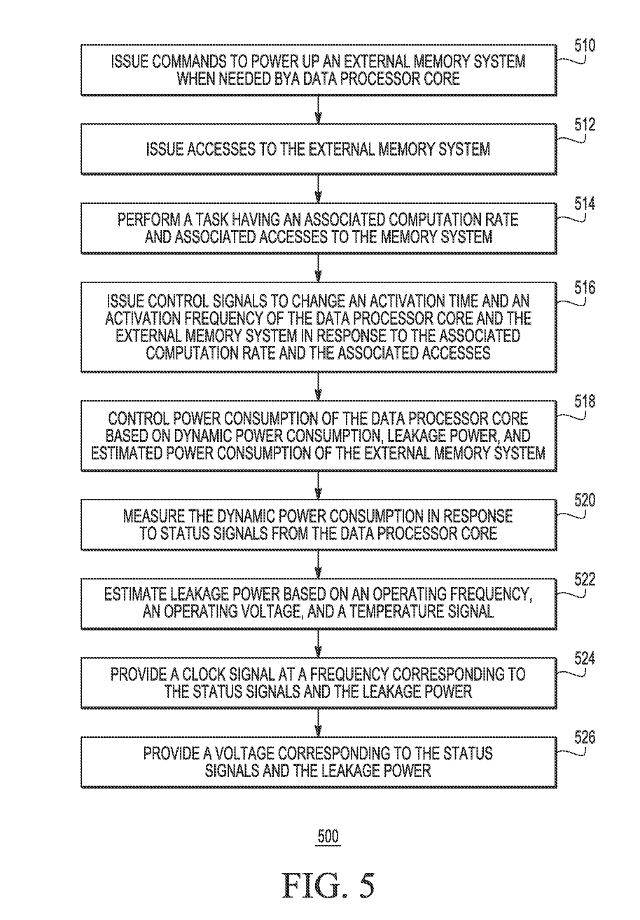

FIG. 5 illustrates a flow diagram of a method 500 for controlling power for data processing system 100 of FIG. 1 according to some embodiments. Action box 510 includes issuing commands to power up an external memory system when needed by a data processor core. Action box 512 includes issuing accesses to the external memory system. Action box 514 includes performing a task having an associated computation rate and associated accesses to the memory system. Action box 516 includes issuing control signals to change an activation time and an activation frequency of the data processor core and the external memory system in response to the associated computation rate and the associated accesses. Action box 518 includes controlling power consumption of the data processor core based on dynamic power consumption, leakage power, and estimated power consumption of the external memory system. Action box 520 includes measuring the dynamic power consumption in response to status signals from the data processor core. Action box 522 includes estimating leakage power based on an operating frequency, an operating voltage, and a temperature signal. Action box 524 includes providing a clock signal at a frequency corresponding to the status signals and the leakage power. Action box 526 includes providing a voltage corresponding to the status signals and the leakage power.

Thus, a data processing system described in some embodiments herein dynamically controls power consumption by considering both the activation time and the activation frequency of both a data processor core and a memory system which it controls. For example, a power controller works with an operating system to change the processing duration and the power state, to lower power while the data processor cores complete each task to achieve an associated computation rate. In some embodiments, a power controller reduces power consumption based on dynamic power consumption, leakage power, and estimated power of an associated external memory system. The power controller 200 can further adjust for changing operating conditions, for example, silicon characteristics, operating temperature, an amount of work to be performed over a time period, a type of work to be performed, and other characteristics of the data processor core performing the calculations.

The functions of data processing system 100 and power controller 200 of FIGS. 1 and 2 may be implemented with various combinations of hardware and software. For example, the set of registers and memory 214, the set of leakage tables 220, and the set of power tables 224 may be determined by a basic input-output system (BIOS), an operating system, firmware, or software drivers, and stored as a table in non-volatile memory. Some of the software components may be stored in a computer readable storage medium for execution by at least one processor. Moreover the method illustrated in FIG. 5 may also be governed by instructions that are stored in a computer readable storage medium and that are executed by at least one processor. Each of the operations shown in FIG. 5 may correspond to instructions stored in a non-transitory computer memory or computer readable storage medium. In various embodiments, the non-transitory computer readable storage medium includes a magnetic or optical disk storage device, solid-state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Moreover, the circuits of FIGS. 1, 2 and 5 may be described or represented by a computer accessible data structure in the form of a database or other data structure which can be read by a program and used, directly or indirectly, to fabricate integrated circuits with the circuits of FIGS. 1 and 2. For example, this data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising integrated circuits with the circuits of FIGS. 1 and 2. The netlist may then be placed and routed to produce a data set describing geometric shapes to be applied to masks. The masks may then be used in various semiconductor fabrication steps to produce integrated circuits of FIGS. 1, 2, and 5. Alternatively, the database on the computer accessible storage medium may be the netlist (with or without the synthesis library) or the data set, as desired, or Graphic Data System (GDS) II data.

While particular embodiments have been described, various modifications to these embodiments will be apparent to those skilled in the art. For example, in the illustrated embodiments, data processing system 100 includes two CPU cores 122 and 126 and one GPU core 132. In some embodiments, data processing system 100 could include a different number of CPU cores and/or GPU cores. CPU cores 122 and 126 and GPU core 132 could be other types of data processor cores than CPU cores or GPU cores, such as digital signal processor (DSP) cores, a video processing core, a multi-media core, a display engine, a rendering engine, and the like. CPU cores 122 and 126 could use a common circuit design or different circuit designs. Also, APU 120 and power controllers 110 and 200 could be formed on a single integrated circuit or could be formed on multiple integrated circuits.

Any combination of CPU cores 122, 126, GPU core 132, voltage regulators 232, PLL 234, and temperature sensor 236, respectively, could be integrated on a single semiconductor chip, or any combination of CPU cores 122, 126, GPU core 132, voltage regulators 232, PLL 234, and temperature sensor 236, respectively, could be on separate chips. For example, voltage regulators 232 could be external voltage regulators, or could be formed on a different integrated circuit external to data processing system 100.

In the illustrated embodiment, power controllers 110 and 200 are a separate function. In some embodiments, some or all of power controllers 110 and 200 could be integrated with another block, such as a data processor core, NB 136, a system management unit (SMU), other components of data processing system 100, etc.

Accordingly, it is intended by the appended claims to cover all modifications of the disclosed embodiments that fall within the scope of the disclosed embodiments.

What is claimed is:

1. A data processing system comprising:
a data processor core adapted to control an external memory system and to perform a task by accessing said external memory system, wherein said task has an associated computation rate, and said data processor is adapted to control said external memory system by powering up said external memory system when needed; and
a power controller coupled to said data processor core for controlling a power consumption of said data processor core and said external memory system by issuing control signals to change an activation time and an activation frequency of said data processor core and said memory system.

2. The data processing system of claim 1 wherein said power controller further controls a power consumption of said data processor core based on dynamic power consumption, leakage power, and estimated power consumption of said memory system.

3. The data processing system of claim 1 wherein said data processor core comprises a graphics processing unit (GPU) core.

4. The data processing system of claim 1 wherein said data processor core comprises a central processing unit (CPU) core.

5. The data processing system of claim 1 further comprising:
a memory controller coupled to said data processor core and adapted to be coupled to said memory system, for reducing a power of said external memory system in response to detecting that said external memory system is not needed.

6. The data processing system of claim 5 wherein:
said memory controller is adapted to reduce a power of said external memory system by placing said external memory system in a self-refresh mode.

7. A data processing system comprising:
a data processor core adapted to control to an external memory system and to perform a task by accessing said external memory system, wherein said task has an associated computation rate, and said data processor is adapted to control said external memory system by powering up said external memory system when needed; and
a power controller coupled to said data processor core for controlling a power consumption of said data processor core based on dynamic power consumption, leakage power, and estimated power consumption of said external memory system.

8. The data processing system of claim 7 wherein said power controller is further adapted to control a power consumption of said data processor core and said external memory system by issuing control signals to change an activation time and an activation frequency of said data processor core and said memory system.

9. The data processing system of claim 7 wherein said data processor core comprises a graphics processing unit (GPU) core.

10. The data processing system of claim 7 wherein said data processor core comprises a central processing unit (CPU) core.

11. The data processing system of claim 7 further comprising:
a memory controller coupled to said data processor core and adapted to be coupled to said memory system, for reducing a power of said external memory system in response to detecting that said external memory system is not needed.

12. The data processing system of claim 11 wherein:
said memory controller reduces a power of said external memory system by placing said external memory system in a self-refresh mode.

13. The data processing system of claim 7, wherein:
said data processor core has an output for providing a plurality of status signals; and
said power controller has an input coupled to said output of said data processor core, and measures said dynamic power consumption in response to said plurality of status signals.

14. The data processor of claim 13, wherein:
said plurality of status signals comprises a battery status signal.

15. The data processing system of claim 13 wherein said data processor core further comprises performance counters and
said plurality of status signals are based on a set of tasks performed over corresponding time periods measured by said performance counters.

16. The data processing system of claim 7, wherein:
said power controller has a second input for receiving a temperature signal, and estimates said leakage power based on an operating frequency, an operating voltage, and said temperature signal.

17. The data processing system of claim 7, wherein:
said power controller estimates said power consumption of said external memory system based on an operating frequency and an operating voltage.

18. A power controller for a data processing system comprising:
a leakage calculator having a first input for receiving a temperature signal, a second input for receiving an operating frequency value, a third input for receiving an operating voltage value, and an output for providing a leakage power signal;
a power calculator and controller circuit having a first input for receiving said operating frequency value, a second input for receiving said operating voltage value, and an output; and
a control signal generator having an input coupled to said output of said power calculator and controller circuit, a first output for providing said operating frequency value, a second output for providing said operating voltage value, a third output for providing a clock signal at a frequency corresponding to said operating frequency value, and a fourth output for providing a voltage corresponding to said operating voltage value.

19. The power controller of claim 18 further comprising:
a capacitance calculator having an input for receiving a plurality of activity signals from said data processing system, and an output for providing a dynamic capacitance value.

20. The power controller of claim 19 wherein said power calculator and controller circuit further has a third input for receiving said dynamic capacitance value.

21. The power controller of claim 18 wherein said power controller further comprises power tables to store power models; and
changing an activation time and an activation frequency of a data processor core and a memory system.

22. The power controller of claim 18 wherein said leakage calculator further comprises leakage tables to store a plurality of values representing a weighted average of active processing leakage power and idle time leakage power, based on silicon characteristics, temperature, and voltage; and
said providing a leakage power signal is based on said values.

23. A method comprising:
issuing commands to power up an external memory system when needed by a data processor core;
issuing accesses to said external memory system;
performing a task having an associated computation rate and associated accesses to said external memory system; and
issuing control signals to change an activation time and an activation frequency of said data processor core and said external memory system in response to said associated computation rate and said associated accesses.

24. The method of claim 23 further comprising:
controlling a power consumption of said data processor core based on dynamic power consumption, leakage power, and power consumption of said external memory system.

25. The method of claim 24 further comprising:
measuring said dynamic power consumption in response to a plurality of status signals from said data processor core.

26. The method of claim 25, wherein:
said plurality of status signals comprises a battery status signal.

27. The method of claim 25 further comprising:
estimating a leakage power based on an operating frequency, an operating voltage, and a temperature signal.

28. The method of claim 27 further comprising:
providing a clock signal at a frequency corresponding to said status signals and said leakage power; and
providing a voltage corresponding to said status signals and said leakage power.
